(19) United States
(12) Patent Application Publication
(10) Pub. No.: US 2026/0167812 A1
(43) Pub. Date: Jun. 18, 2026

(54) RESIN COMPOSITIONS FOR LASER COLOR MARKING AND METHODS OF USING THE SAME

(71) Applicant: Ampacet Corporation, Tarrytown, NY (US)

(72) Inventors: Wes Houghton, Larchmont, NY (US); Mercedes Landazuri, Chicago, IL (US); William Andrews, Newark, OH (US); Adam Wolfe, Terre Haute, IN (US)

(21) Appl. No.: 19/425,559

(22) Filed: Dec. 18, 2025

Related U.S. Application Data
(60) Provisional application No. 63/735,863, filed on Dec. 18, 2024.

(51) Int. Cl. C08L 25/06; B29B 9/06; B29K 25/00; B29K 96/04; B41M 5/26; C08K 3/04; C08K 3/26; C08K 3/34; C08K 5/00; C08K 5/524; C08K 9/02

(52) U.S. Cl. CPC C08L 25/06; B29B 9/06; B41M 5/267; C08K 3/04; C08K 3/34; C08K 5/0041; C08K 5/524; C08K 9/02; B29K 2025/06; B29K 2096/04; B29K 2995/002; B29K 2995/0037; C08K 2003/265; C08L 2205/025; C08L 2310/00

(57) ABSTRACT

Resin compositions adapted for producing thermal chemical surface reactions upon laser application to yield laser markings at a surface of the resin composition. The resin compositions are formulated to have an undertone coloration and an overall surface coloration and are adapted such that laser markings generated at the surface may be made with chromatic, non-grayscale target colors having a high contrast and shading relative to a black or other dark surface coloration.

### FIELD OF THE INVENTION

The present disclosure relates to resin compositions for color laser marking and methods of using the same. In particular, the present disclosure is directed to resin compositions adapted to enable laser marking in a wide range of colors beyond those available via conventional methods.

### BACKGROUND OF THE INVENTION

Conventional laser marking methods include the application of a laser beam to a surface of an object to create a marking thereon. Markings created by conventional methods are only capable of effecting changes to the lightness of a surface, resulting in laser markings that typically have an achromatic grayscale color representing shades of gray or white. When used to mark objects with black colored surfaces, these conventional methods yield unsatisfactory results as the resulting grayscale mark typically has a low contrast against the black surface.

There remains a need for improvements to laser marking technology to enable laser markings with varying chromatic colors beyond the achromatic grayscale colors possible from conventional methods, and which enables greater contrast when marking black surfaces.

### SUMMARY OF THE INVENTION

The present disclosure provides resin compositions adapted for producing thermal chemical surface reactions upon laser application to yield laser markings at a surface of the resin composition. The resin compositions are formulated to have an undertone coloration and an overall surface coloration and are adapted such that laser markings generated at the surface may be made with chromatic, non-grayscale target colors having a high contrast and shading relative to a black or other dark surface coloration. Both the foregoing general description and the following detailed description are exemplary and explanatory only and are intended to provide further explanation of the disclosure.

### DETAILED DESCRIPTION OF THE INVENTION

The use of any and all examples, or exemplary language (e.g., “such as”) provided herein is intended merely to better illuminate the disclosure and does not pose a limitation on the scope of the disclosure unless otherwise claimed. No language in the specification should be construed as indicating any non-claimed element as essential or otherwise critical to the practice of the disclosure, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially”, as used herein with respect to any property or circumstance, refers to a degree of deviation that is sufficiently small so as to not appreciably detract from the identified property or circumstance. The exact degree of deviation allowable in a given circumstance will depend on the specific context, as would be understood by one having ordinary skill in the art.

Use of the terms “about” or “approximately” are intended to describe values above and/or below a stated value or range, as would be understood by one having ordinary skill in the art in the respective context. In some instances, this may encompass values in a range of approx. +/−10%; in other instances, there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

Recitations of value ranges herein, unless indicated otherwise, serve as shorthand for referring individually to each separate value falling within the respective ranges, including the endpoints of the range, each separate value within the range, and all intermediate ranges subsumed by the overall range, with each incorporated into the specification as if individually recited herein.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

The present disclosure is inclusive of resin compositions that enable laser markings across a broad spectrum of chromatic colors, including markings applied to black surfaces. Resin compositions according to the present disclosure enable the creation of laser markings that effect a change to not only the lightness of the surface color but also the chroma thereof. This enables the creation of laser markings in chromatic, non-grayscale colors such as, though not limited to red, orange, yellow, green, blue, and purple.

In some examples, resin compositions according to the present disclosure may be used to fabricate a plastic component with a black or other generally dark coloration, with a surface adapted for laser marking to yield a color marking having a difference in both lightness and chroma, relative to the color of the surface prior to laser marking, thereby creating a high contrast chromatic color marking relative to the black surface coloration. Plastic components in such examples may be formed by any suitable means, such as, though not limited to injection molding, extrusion, blow molding, and thermoforming. In other examples, resin compositions according to the present disclosure may be applied as a surface treatment to a prefabricated part, thereby providing the prefabricated part with a surface adapted for laser marking to yield a chromatic color marking having a difference in both lightness and chroma, with a high contrast relative to a black surface coloration.

Thermoplastic resin compositions according to the present disclosure may be composed of one or more resins, a foaming agent, an absorbance additive, an antioxidant, and one or more colorants. Optionally, the resin compositions may comprise a single component having both foaming and absorbance properties (e.g., Iriotec 8835) in place of two separate components of a foaming agent and a separate absorbance additive. The resin compositions may, optionally, include one or more foaming aids, color additives such as carbon black, and one or more fillers.

Examples of suitable foaming agents and aids include, though are not limited to, talc, calcium carbonate, Iriotec 8835, sodium carbonate, magnesium carbonate, aluminum hydroxide, and combinations thereof. The foaming agent is present in an amount of 0.2-0.7 wt. % of the resin composition. The absorbance additive is a material with a relatively high absorbance in the near infrared (NIR) range, 700-2500 nm. Examples of suitable absorbance additives for inclusion in the resin composition include, though are not limited to mica, black iron oxide (Fe₃O₄), Iriotec 8835, and combinations thereof. The absorbance additive is present in an amount of 0.3-0.5 wt. % of the resin composition. The resin composition may include any suitable antioxidant present in an amount of up to 0.008 wt. % of the resin composition. The resin composition may include any suitable antioxidant present in an amount up to 0.008 wt. % of the resin composition, which may include the absence of an antioxidant or the presence of an antioxidant in a non-zero amount in a range of greater than 0 wt. % and up to 0.008 wt. %.

The one or more colorants is composed of a selection of dyes and/or pigments customized to yield a target color desired for the chromatic color marking that is to be produced by laser marking. Examples of dyes include though are not limited to solvent blue 104, solvent violet 13, solvent red 52, solvent red 179, solvent yellow 114, solvent green 28, etc., and combinations thereof. Examples of pigments include through are not limited to pigment brown 29, pigment blue 28, and pigment yellow 53, etc., and combinations thereof. The one or more colorants are present in an amount of 0.25-0.9 wt. % of the resin composition. Carbon black may optionally be present in a minimally effective amount, not to exceed 0.15 wt. % of the resin composition, if needed to achieve a target background color (e.g., a black or other dark surface coloration) without muting the undertone of the resin composition provided by the color component. While not being bound by theory, carbon black may be beneficial when seeking to achieve a black background in resin compositions in which the colorant is composed of pigments, whereas colorants composed of dyes may be capable of achieving a black coloration in relatively high loadings without need for carbon black. Proper weighting of the colorants, and any optional carbon black, yields a natural black surface appearance while maintaining an undertone from the colorant such that application of a laser to the black surface yields a laser marking with a chromatic target color corresponding with the specific colorant formulation.

Thermoplastic resins for use in the resin compositions may include, though are not limited to, polystyrene (PS), acrylonitrile butadiene styrene (ABS), polycarbonate (PC), polyamide (PA), polypropylene (PP), and combinations thereof. The thermoplastic resin may make up the remainder of the resin composition.

Resin compositions according to the present disclosure may be made through a plastic processing method in which a composition material feed is introduced into a plastic processing machine for production of a plastic product embodying the resin composition (e.g., a manufactured product or surface layer treatment). The composition feed comprises a first material feed in the form of a polymer and a second material feed in the form of a resin masterbatch. The polymer and resin masterbatch are fed in small particle forms that may be referred to interchangeably as “pellets”, “beads”, and “granules”, and which typically have a weight in a range of 0.01 g-0.04 g.

The polymer is a plastic material for formation of the plastic product and may also commonly be referred to as a “raw material” or “virgin”. The resin masterbatch is a concentrated mixture of the components for forming the resin composition encapsulated in a carrier resin and pelletized. Pellets in the resin masterbatch have a composition in which the foaming agent is present in an amount of 5.0-18.0 wt. %, the colorant is present in an amount of 1.0-25.0 wt. %, the absorbance additive is present in an amount of 9.0-12.5 wt. %, and the carbon black is present in an amount not to exceed 3.75 wt. %. The thermoplastic resin may make up the remainder of the pellet composition and may be present in an amount up to 65 wt. %. The composition feed may be fed to the processing machine with the resin masterbatch having a let-down ratio of 1.0-8.0% of the polymer feed, and optionally at a ratio of 2.0-4.0%.

In use, an object having a surface composed of a resin composition according to the present disclosure may be laser marked by any conventional laser, such as, though not limited to, a Yttrium Aluminum Garnet (YAG) laser, a fiber laser, a vanadate laser, and a carbon dioxide (CO₂) laser. The laser may be operated to output a beam with an NIR wavelength in the range of 1060 nm to 1070 nm, in a range of 10-150 kHz, at a power of up to 20 W, with a scan speed in a range of 1 cm/s to 5 cm/s.

Application of a laser light against a surface formed of the resin composition results in thermal chemical surface reactions that produce a bubbling effect at the laser marked surface regions. The bubbling effect reveals the undertone coloration corresponding with the specific colorant formulation for the given resin composition.

Each of Samples A-F, as addressed in Table I below, were prepared by mixing 5 wt. % calcium carbonate, 12.5 wt. % Iriotec 8835, 0.2 wt. % Phosphite Phenolic Antioxidant 215, 52 wt. % general purpose polystyrene (GPPS) 15 MFI, 22.3 wt. % KR03 K-Resin 7.5 MFI, and 8 wt. % colorant. The mixture was tumbled in a shaker for five minutes and then fed into the hopper of an extruder and re-pelletized into masterbatch form. The masterbatch pellets were then added to GPPS pellets at a let-down ratio of 4%. The masterbatch and virgin resin blend was then fed into the hopper of an injection molder and injected into a mold to form a plaque, with the masterbatch transforming the color of the previously clear virgin resin into a semi-opaque, black-appearing color.

A separate plaque was generated for each of the Samples A-F, with each plaque having a composition comprising 0.2 wt. % calcium carbonate, 0.5 wt. % Iriotec 8835, 0.008 wt. % Phosphite Phenolic Antioxidant 215, 2.08 wt. % GPPS 15 MFI, 0.892 wt. % KR03 K-Resin 7.5 MFI, 0.32 wt. % colorant, and 96 wt. % GPPS resin substrate. Each plaque was laser marked by a fiber laser with an average wavelength of 1064 nm, at 60 kHz and 12 W, with an average scan speed of 1 cm/s.

TABLE I

| | Inventive Samples | | | | | | |
|---|---|---|---|---|---|---|---|
| | A | B | C | D | E | F | X |
| Masterbatch (wt. %) | | | | | | | |
| Calcium Carbonate | 5 | 5 | 5 | 5 | 5 | 5 | 0 |
| Iriotec 8835 | 12.5 | 12.5 | 12.5 | 12.5 | 12.5 | 12.5 | 13.34 |
| Phosphite Phenolic Antioxidant 215 | 0.2 | 0.2 | 0.2 | 0.2 | 0.2 | 0.2 | 0 |
| GPPS 15 MFI | 52 | 52 | 52 | 52 | 52 | 52 | 0 |
| KR03 K-Resin 7.5 MFI | 22.3 | 22.3 | 22.3 | 22.3 | 22.3 | 22.3 | 0 |
| Solvent Blue 104 | 8 | 0 | 0 | 0 | 0 | 0 | 0 |
| Solvent Violet 13 | 0 | 8 | 0 | 0 | 0 | 0 | 0 |
| Solvent Red 52 | 0 | 0 | 8 | 0 | 0 | 0 | 0 |
| Solvent Red 179 | 0 | 0 | 0 | 8 | 0 | 0 | 0 |
| Solvent Yellow 114 | 0 | 0 | 0 | 0 | 8 | 0 | 0 |
| Solvent Green 28 | 0 | 0 | 0 | 0 | 0 | 8 | 0 |
| LLDPE 20 MFI | 0 | 0 | 0 | 0 | 0 | 0 | 53.79 |
| Pigment Blue 29 | 0 | 0 | 0 | 0 | 0 | 0 | 26.67 |
| Carbon Black | 0 | 0 | 0 | 0 | 0 | 0 | 5 |
| PE Wax | 0 | 0 | 0 | 0 | 0 | 0 | 1 |
| Antioxidant 900 | 0 | 0 | 0 | 0 | 0 | 0 | 0.2 |
| Resin (wt. %) | | | | | | | |
| Calcium Carbonate | 0.2 | 0.2 | 0.2 | 0.2 | 0.2 | 0.2 | 0 |
| Iriotec 8835 | 0.5 | 0.5 | 0.5 | 0.5 | 0.5 | 0.5 | 0.4 |
| Phosphite Phenolic Antioxidant 215 | 0.008 | 0.008 | 0.008 | 0.008 | 0.008 | 0.008 | 0 |
| GPPS 15 MFI | 2.08 | 2.08 | 2.08 | 2.08 | 2.08 | 2.08 | 0 |
| KR03 K-Resin 7.5MFI | 0.892 | 0.892 | 0.892 | 0.892 | 0.892 | 0.892 | 0 |
| Solvent Blue 104 | 0.32 | 0 | 0 | 0 | 0 | 0 | 0 |
| Solvent Violet 13 | 0 | 0.32 | 0 | 0 | 0 | 0 | 0 |
| Solvent Red 52 | 0 | 0 | 0.32 | 0 | 0 | 0 | 0 |
| Solvent Red 179 | 0 | 0 | 0 | 0.32 | 0 | 0 | 0 |
| Solvent Yellow 114 | 0 | 0 | 0 | 0 | 0.32 | 0 | 0 |
| Solvent Green 28 | 0 | 0 | 0 | 0 | 0 | 0.32 | 0 |
| GPPS or PP Resin Substrate | 96 | 96 | 96 | 96 | 96 | 96 | 97 |
| LLDPE 20 MFI | 0 | 0 | 0 | 0 | 0 | 0 | 1.614 |
| Pigment Blue 29 | 0 | 0 | 0 | 0 | 0 | 0 | 0.8 |
| Carbon Black | 0 | 0 | 0 | 0 | 0 | 0 | 0.15 |
| PE Wax | 0 | 0 | 0 | 0 | 0 | 0 | 0.03 |
| Antioxidant 900 | 0 | 0 | 0 | 0 | 0 | 0 | 0.006 |

As seen in Table I, Samples A-F are made from near identical masterbatch compositions and result in near identical resin compositions, with the only differences being the chosen colorant of the masterbatch compositions and the resulting colorant of the resin compositions. In this way, Samples A-F illustrate an advantage of the resin compositions disclosed herein, in that it enables production of a chromatic color marking of any target color through simple substitution a colorant component, without necessitating changes to other components of the masterbatch composition. Samples A-F are thus illustrative of an advantageous flexibility of the resin composition and do not limit the broader disclosure of the resin composition or the processes relative thereto as presented herein.

Table I further includes data for a comparative Sample X representing data from a white (grayish) laser marking on a black background. Comparative Sample X differs in composition from the Samples A-F in that it is composed of Iriotec 8835 in combination with linear low-density polyethylene (LLDPE) with a colorant composed of a pigment (pigment blue 29) and carbon black for achieving the overall black surface coloration with target undertone coloration, with polyethylene (PE) wax and an antioxidant. Apart from the compositional differences, Sample X was prepared according to the same process as was used to prepare Samples A-F. The inclusion of comparative Sample X provides further context for the beneficial results enabled by the resin compositions disclosed herein.

As shown in Table II below, Samples A-F yield chromatic color markings having L*a*b*C values that differ noticeably in each of lightness value (L*), red-green value (a*), yellow-blue value (b*), and chroma value (C) relative to the L*a*b*C values of the respective black backgrounds, with a variance of at least approximately 8.99 for the lightness value (L*), variances of at least approximately 2.64 for the red-green value (a*) and 2.67 for the yellow-blue value (b*), and a variance of at least approximately 6.99 for the chroma value (C).

TABLE II

| Visual Results | | A | B | C | D | E | F | X |
|---|---|---|---|---|---|---|---|---|
| Mark Color | | Blue | Violet | Pink | Orange | Yellow | Green | White |
| Black Background | L* | 27.54 | 27.34 | 27.78 | 28.07 | 28.87 | 27.77 | 25.56 |
| (L*a*b*C) | a* | 0.22 | 0.48 | 2.03 | 2.14 | 0.34 | −0.73 | 0.24 |
| | b* | −2.14 | −2.05 | −1.36 | −0.20 | 1.27 | −1.00 | −0.36 |
| | C | 2.15 | 2.10 | 2.44 | 2.15 | 1.31 | 1.24 | 0.43 |
| Color Mark | L* | 40.64 | 36.33 | 37.20 | 43.89 | 48.24 | 39.00 | 53.30 |
| (L*a*b*C) | a* | −4.86 | 3.16 | 17.89 | 18.78 | −2.30 | −8.06 | −0.36 |
| | b* | −13.79 | −12.6 | −6.04 | 7.66 | 25.59 | 1.67 | 1.43 |
| | C | 14.62 | 12.99 | 18.88 | 15.12 | 25.69 | 8.23 | 1.47 |
| Black-Color Variance | ΔL* | 13.1 | 8.99 | 9.42 | 15.82 | 19.37 | 11.23 | 27.74 |
| (ΔL*a*b*C) | Δa* | 5.08 | 2.68 | 15.86 | 16.64 | 2.64 | 7.33 | 0.59 |
| | Δb* | 11.65 | 10.55 | 4.68 | 7.86 | 24.32 | 2.67 | 1.79 |
| | ΔC | 12.47 | 10.89 | 16.44 | 12.97 | 24.38 | 6.99 | 1.04 |
| Total Color Difference | ΔE_{ab} | 18.25 | 14.12 | 19.03 | 24.27 | 31.20 | 13.67 | 27.80 |
| RGBY Difference | ΔD_{ab} | 12.71 | 10.89 | 16.53 | 18.40 | 24.46 | 7.80 | 1.88 |

Comparative Sample X is provided with L*a*b*C values for the black background and the generally achromatic white marking applied thereto, with L*a*b*C variances of 27.74 for the lightness value (L*), 0.59 for the red-green value (a*), 1.79 for the yellow-blue value (b*), and 1.04 for the chroma value (C). Comparing Samples A-F with Sample X, it is seen that while Sample X yields a noticeably larger variance for the lightness value (L*), corresponding with the relatively high contrast between black and white, Sample X yields only minimal differences for each of the red-green value (a*), yellow-blue value (b*), and chroma value (C) values.

The ability of the human eye to perceive differences in total color may be measured via the following formula (1), which is referred to herein as the total color difference Delta E_{ab} (ΔE_{ab}):

$$Δ {E}_{ab}^{*} = \sqrt{{( Δ {L}^{*} )}^{2} + {( Δ {a}^{*} )}^{2} + {( Δ {b}^{*} )}^{2}} \qquad ( 1 )$$

In formula (1), ΔL* represents the variance in lightness (L*), Δa* represents the variance in red-green (a*), Δb* represents the variance in yellow-blue (b*). Without being bound by theory, it has been estimated that a just noticeable difference (JND), as a threshold for perception of color difference, is approximately ΔE_{ab}≅2.3 (Sharma, G., 2003, Digital Color Imaging Handbook, 1.7.2 ed, CRC Press, and ISBN 0-8493-0900-X, 31-32). As seen in Table II above, each of Samples A-F and Sample X have ΔE_{ab} values well above the perception threshold.

While total color difference ΔE_{ab} is useful in measuring perception of total color, a measurement of perceived color intensity may be assessed via the below formula (2), which is commonly referred to as chroma difference Delta C_{ab} (ΔC_{ab}). In the interest of avoiding confusion with the chroma variance (ΔC) as discussed herein, the chroma difference ΔC_{ab} may also be referred to herein as the RGBY difference Delta D_{ab} (ΔD_{ab}), as shown in Table II above and as conveyed by the following formula (2):

$$Δ {D}_{ab} = Δ {C}_{ab} = \sqrt{{( Δ {a}^{*} )}^{2} + {( Δ {b}^{*} )}^{2}} \qquad ( 2 )$$

In formula (2), Δa* represents the variance in red-green (a*), Δb* represents the variance in yellow-blue (b*). Formula (2) enables an isolated assessment of color intensity by omitting the lightness (L*) value, thereby emphasizing differences in color coordinates associated with the red-green (a*) and yellow-blue (b*) values. As seen in Table II above, the Sample X has an RGBY difference value of only ΔD_{ab}=1.88, well below the 2.3 JND threshold, whereas each of the Samples A-F have RGBY difference values ΔD_{ab} well above the 2.3 JND threshold.

Resin compositions according to the present disclosure, as evidenced though not limited to Samples A-F, represent an improvement in laser marking technology in that they enable laser markings with enhanced perceptible differences in color intensity.

Although the present disclosure references particular examples, it will be understood to those skilled in the art that the disclosure is not limited to the disclosed embodiments; and that the disclosure may encompass any combination of the disclosed examples, in whole or in part, as well as additional examples embracing various changes and modifications relative to the examples disclosed herein without departing from the scope of the disclosure and the appended claims and equivalents thereto.

To the extent necessary to understand or complete the present disclosure, all publications, patents, and patent applications mentioned herein are expressly incorporated by reference herein to the same extent as though each were individually so incorporated.

The claims appended hereto are not limited to the examples addressed herein, and the appended claims in no way limit the scope of the disclosure.

What is claimed is:

1. A thermoplastic resin composition comprising:
one or more thermoplastic resins;
an absorbance additive having an absorbance in a range of 700 nm to 2500 nm;
one or more colorants present in an amount of 0.25-0.9 wt. % of the resin composition, the one or more colorants formulated to present a surface coloration of a relatively low chroma with an undertone coloration of a relatively high chroma; and
an antioxidant present in an amount up to 0.008 wt. % of the resin composition, wherein
the resin composition is adapted to present a surface with the relatively low chroma coloration that is responsive to laser radiation to produce a marking having the relatively high chroma coloration.

2. The thermoplastic resin composition according to claim 1, wherein
the surface presenting the relatively low chroma coloration that is responsive to laser radiation to produce the relatively high chroma coloration marking is a single layer surface.

3. The thermoplastic resin composition according to claim 1, wherein
the surface is responsive to laser radiation to effect a thermal chemical surface reaction that produces a bubbling effect at laser radiated regions, with the bubbling effect yielding the relatively high chroma coloration marking.

4. The thermoplastic resin composition according to claim 1, wherein
the surface responsive to laser radiation is adapted to produce the relatively high chroma coloration marking with an RGBY difference ΔD_{ab}>2.3 relative to the relatively low chroma coloration.

5. The thermoplastic resin composition according to claim 4, wherein
the surface is adapted to produce the relatively high chroma coloration marking with L*a*b*C values in which each of the lightness value (L*), the red-green value (a*), the yellow-blue value (b*), and the chroma value (C) has a variance greater than 2.3 relative to the L*a*b*C values of the relatively low chroma coloration.

6. The thermoplastic resin composition according to claim 1, wherein
the one or more colorants comprises one or more solvent dyes.

7. The thermoplastic resin composition according to claim 1, wherein
the one or more colorants comprises one or more pigments.

8. The thermoplastic resin composition according to claim 7, wherein
the resin composition further comprises carbon black in an amount less than or equal to 0.15 wt. % of the resin composition.

9. The thermoplastic resin composition according to claim 1, further comprising
a foaming agent present in an amount of 0.2-0.7 wt. % of the resin composition.

10. The thermoplastic resin composition according to claim 1, wherein
the absorbance additive is present in an amount of 0.3-0.5 wt. % of the resin composition.

11. The thermoplastic resin composition according to claim 1, wherein
the absorbance additive has foaming properties to also serve as a foaming agent.

12. The thermoplastic resin composition according to claim 11, wherein
the absorbance additive is present in an amount of 0.5-1.2 wt. % of the resin composition.

13. An article of manufacture comprising a component fabricated from the thermoplastic resin composition according to claim 1.

14. An article of manufacture comprising a component coated with the thermoplastic resin composition according to claim 1.

15. A method of making the thermoplastic resin composition according to claim 1, comprising:
preparing a mixture of one or more thermoplastic resins, an absorbance additive having an absorbance in a range of 700 nm to 2500 nm, one or more colorants, and optionally an antioxidant;
preparing a pelletized masterbatch from the prepared mixture;
preparing a masterbatch blend combining the pelletized masterbatch with virgin resin pellets;
feeding the masterbatch blend to processing machine.

16. The method of claim 15, wherein
the processing machine outputs the thermoplastic resin composition as a plastic article formed of the thermoplastic resin composition.

17. The method of claim 15, wherein
the processing machine outputs the thermoplastic resin composition as a coating composition for coating of a prefabricated article.

18. A method of laser marking an article, comprising:
exposing an article comprising the thermoplastic resin composition of claim 1 to laser radiation, with the laser radiation applied to the surface presenting the relatively low chroma coloration that is responsive to laser radiation to produce the relatively high chroma coloration marking.

19. The method of claim 18, wherein
the laser radiation is applied
with a wavelength in the range of 1060 nm to 1070 nm,
with a frequency in a range of 10-150 kHz,
at a power of up to 20 W, and
with a scan speed in a range of 1 cm/s to 5 cm/s.

20. The method of claim 18, wherein
the application of laser radiation produces the relatively high chroma coloration marking with an RGBY difference ΔD_{ab}>2.3 relative to the relatively low chroma coloration.
